(19) United States
(12) Patent Application Publication
(10) Pub. No.: US 2017/0034235 A1
(43) Pub. Date: Feb. 2, 2017

(54) ELECTRONIC DEVICE, COMMUNICATION SYSTEM AND METHOD FOR TRANSMITTING/RECEIVING AUDIO AND VIDEO DATA

(71) Applicant: Browan Communications Inc., Hsinchu County (TW)

(72) Inventors: Cheng-Jen Yang, Hsinchu (TW); Yung-Hua Chao, Hsinchu (TW)

(21) Appl. No.: 14/810,455

(22) Filed: Jul. 27, 2015

(51) Int. Cl. H04L 29/06; G06F 3/0482; G06F 3/0481

(52) U.S. Cl. CPC H04L 65/60; G06F 3/04817; G06F 3/0482; H04L 63/0876; H04L 63/123

(57) ABSTRACT

An electronic device includes a display unit, a network element and a processing unit, wherein the processing unit is arranged to connect to a first server via the network element to download a webpage displayed on the display unit, wherein when a specific icon in the webpage is selected, the processing unit receives an authentic information from the first server, and transmits/receives an audio video data with the authentic information and a second server.

### BACKGROUND OF THE INVENTION

1. Field of the Invention

The present invention relates to an audio video data transmission method, and more particularly, to a real-time audio video data transmission method and associated electronic device and communication system.

2. Description of the Prior Art

The interface connector of a software development kit (SDK), which is arranged to produce webpages or transmit real-time audio video data, is usually compiled in C language for facilitating connection with other programs. Webpage developers still need to spend time to learn the syntax of the SDK which results in an inconvenient experience for a user.

At the same time, if webpage developers want to integrate the functions of real-time audio video data transmission, they may encounter problems with data transmission since data of webpages is downloaded batch by batch.

### SUMMARY OF THE INVENTION

One of the objectives of the present invention is therefore to provide a real-time audio video data transmission method and an associated electronic device and communication system to solve the problems described above.

According to an embodiment of the present invention, an electronic device comprises a display unit, a network element and a processing unit, wherein the processing unit is arranged to connect to a first server via the network element for downloading a webpage displayed on the display unit, wherein when a specific icon in the webpage is selected, the processing unit receives an authentic information from the first server, and transmits/receives audio video data with the authentic information to/from a second server.

According to another embodiment of the present invention, a communication system comprises a first server, a second server and an electronic device, wherein the electronic device is arranged to connect to the first server for downloading a webpage displayed on a display unit of the electronic device, wherein when a specific icon in the webpage is selected, the electronic device receives an authentic information from the first server, and transmits/receives audio video data with the authentic information to/from the second server.

According to yet another embodiment of the present invention, an audio video data transmission method comprises: connecting to a first server for downloading a webpage displayed on a display unit; when a specific icon in the webpage is selected, receiving an authentic information from the first server; and transmitting/receiving audio video data with the authentic information to/from the second server.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating a communication system according to an embodiment of the present invention.

FIG. 3 is a flowchart illustrating a audio video data transmission method according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should not be interpreted as a close-ended term such as “consist of”. Also, the term “couple” is intended to mean either an indirect or direct electrical connection. Accordingly, if one device is coupled to another device, that connection may be through a direct electrical connection, or through an indirect electrical connection via other devices and connections.

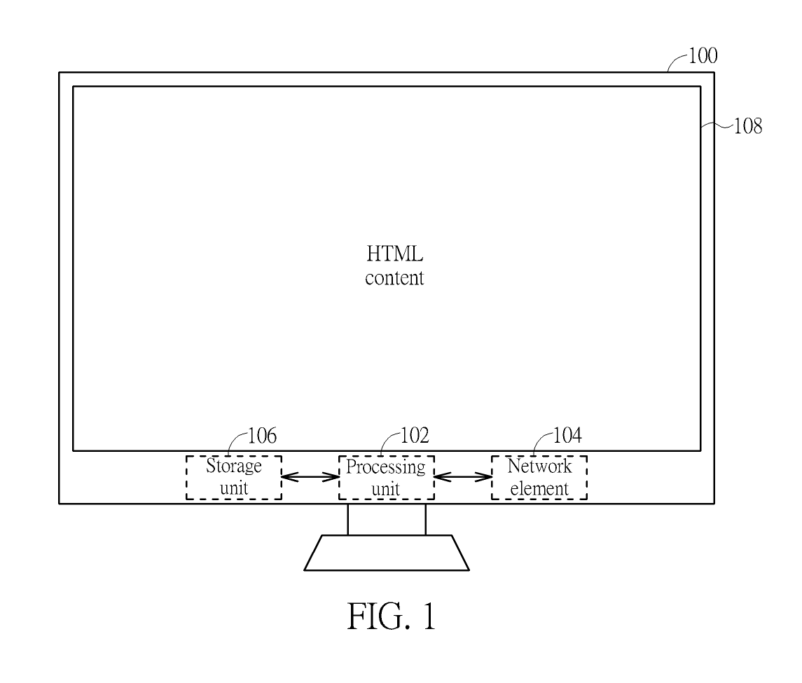

FIG. 1 is a diagram illustrating an electronic device 100 according to an embodiment of the present invention. As shown in FIG. 1, the electronic device 100 comprises a processing unit 102, a network element 104, a storage unit 106 and a display unit 108, wherein in this embodiment, the electronic device 100 may be a smart TV, but in other embodiments, the electronic device 100 may be an electronic device which has network function such as a desktop computer, a laptop, a smart phone or a tablet. In addition, the network element 104 can be a network interface element connecting to cable network or a wireless communication element corresponding to the current spec of radio frequency wireless communication. The processing unit 102 may be a control circuit comprising a processing unit, a plurality of chip sets and/or associated circuitry elements. The storage unit 106 stores a SDK which provides an interface connector in HyperText Markup Language (HTML) or Javascript for the connection of other programs.

In this embodiment, the SDK comprises a part of a browser or an application and a plurality of interface connector icons related to online meetings or lectures such as create account, login, paying mechanism, video upload/download. The webpage developers can select these interface connector icons directly from the HTML content of the display unit 108 when editing a webpage to build desirable functions. Because the SDK utilizes HTML or Javascript, it is unnecessary for webpage developers to spend too much time learning the syntax of the SDK; instead, they can focus on developing the content of the webpage.

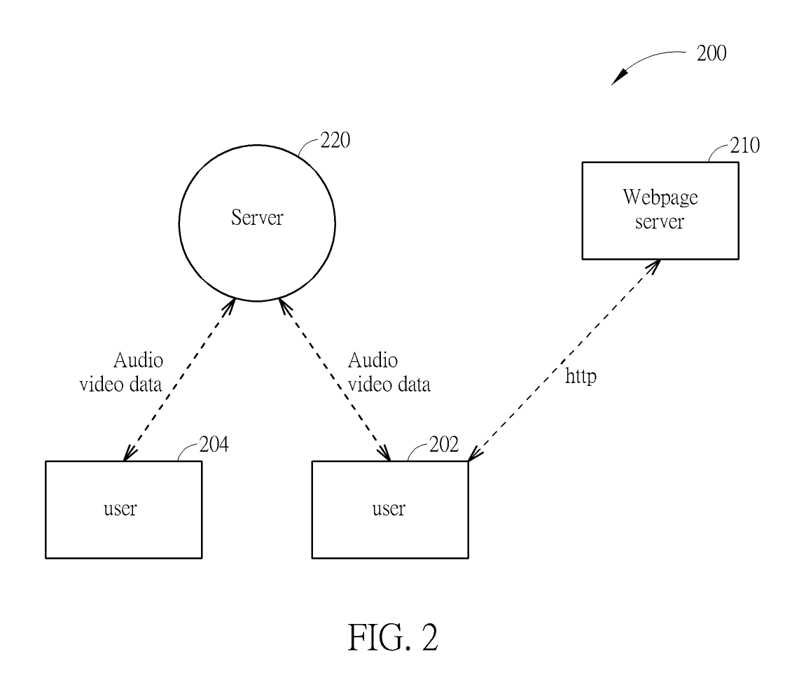

FIG. 2 is a diagram illustrating a communication system 200 according to an embodiment of the present invention. As shown in FIG. 2, the communication system 200 comprises a plurality of users (wherein only the users 202 and 204 are depicted in this embodiment), a webpage server 210 and a server 220, wherein the webpage server 210 stores the webpage content related to online meetings or lectures built by the webpage developers. The users 202 and 204 may be the electronic device 100 shown in FIG. 1. In this embodiment, webpage server 210 only allows some of the users to connect to the webpage, while forbidding general users to connect to the webpage server 210 via the browser. For example, the webpage server 210 can be connected only when the electronic device of the user 202 has downloaded the associated application.

In the operation of the communication system 200, the user 202 connects to the webpage server 210 for downloading the webpage content of the online meeting or lecture. Next, the user 202 can select the icon of online registration, logging in, paying or performing meeting/lecture for starting the associated operation. In this embodiment, because the operation of online registration, logging in and paying is well-known to persons skilled in the art, the detailed description is omitted. The following explanation only details the transmission of audio video data.

When the user selects the icons which will perform audio video transmission such as online meeting/lecture, the webpage 210 transmits an authentic information to the user 202, wherein the authentic information comprises a group identified number of the online meeting or the online lecture, and the group identified number may be a conference/class room number, a lecture number, etc. After receiving the authentic information, the application of the user 202 actively transfers the authentic information to the server 220 to perform an arrangement of the audio video data transmission. After receiving the authentic information sent from the user 202, the server 220 determines what audio video transmission should be performed or which user is chosen to perform the audio video transmission according to the group identified number carried by the authentic information. More specifically, after the server 220 confirms the content of the authentic information, the audio video data can be transmitted to the user 202 for watching uni-directionally, or make the user 202 perform the real-time audio video data transmission with the user 204 via the server 220 (i.e. real-time video call). In addition, the transmission of the audio video data can employ the format of real-time transport protocol, Voice over IP or any other suitable multimedia transmission protocol.

In the embodiment shown in FIG. 2, because there is a specified server responsible for the transmission of the audio video data, the audio video data transmission will not have the problems associated with the prior art.

In an embodiment, when the number in the online conference/class room built by the server 202 has reached its maximum, the server 220 can automatically transfer the user 202 to another server to perform the arrangement of the audio video data transmission, or the server 220 can actively transmit a new IP address to the user 202 so the user 202 can use the new IP address to connect to another server, and transmits the authentic information obtained from the webpage server 210 to the other server for performing the arrangement of audio video data transmission, wherein the function of the other server is substantially equal to the function of the server 220.

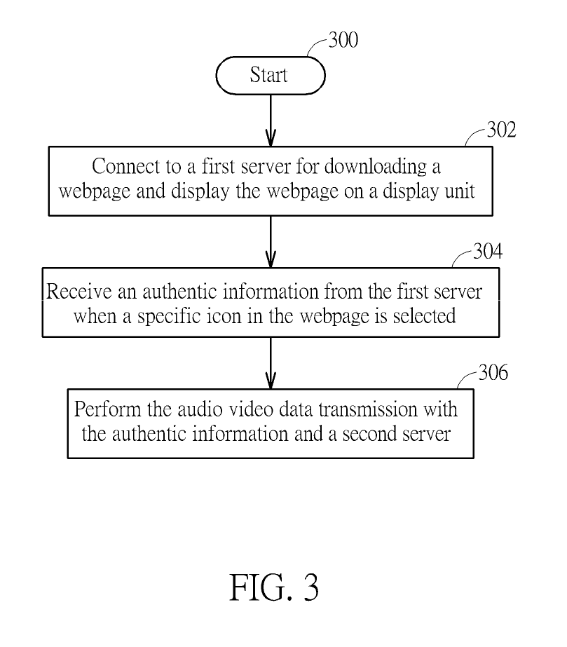

FIG. 3 is a flowchart illustrating an audio video data transmission method according to an embodiment of the present invention which can be applied in an electronic device. As shown in FIG. 3, the flow is described as follows:

Step 300: start.

Step 302: connect to a first server for downloading a webpage and display the webpage on a display unit.

Step 304: receive an authentic information from the first server when a specific icon in the webpage is selected.

Step 306: perform the audio video data transmission with the authentic information and a second server.

Briefly summarized, because the employed SDK in the electronic device of the present invention adopts HTML or Javascript, it is not necessary for the webpage developers to spend much time learning the syntax of the SDK; instead, they can focus on the development of the content of the webpage. In addition, in the communication system of the present invention, the user can connect to a desired online conference/class room via a webpage server and another specified server for providing audio video transmission, with improved quality when watching the real-time audio video data.

Those skilled in the art will readily observe that numerous modifications and alterations of the device and method may be made while retaining the teachings of the invention. Accordingly, the above disclosure should be construed as limited only by the metes and bounds of the appended claims.

1. An electronic device, comprising:
a display unit,
a network element; and
a processing unit, arranged to connect to a first server via the network element for downloading a webpage, and to display the webpage on the display unit;
wherein when a specific icon in the webpage is selected, the processing unit receives an authentic information from the first server, and performs an audio video data transmission with the authentic information and a second server;
wherein when the second server and the electronic device cannot perform the audio video data transmission, the processing unit receives an IP address from the second server, and the processing unit automatically employs the IP address to connect to a third server, and employs the authentic information obtained from the first server to perform the audio video data transmission with the third server.

2. The electronic device of claim 1, wherein the webpage provides a content of an online meeting or an online lecture, and provides an account log in and/or a paying mechanism.

3. The electronic device of claim 2, wherein the authentic information comprises a group identified number of the online meeting or the online lecture.

4. The electronic device of claim 3, wherein the processing unit employs the authentic information to log in to the second server, and perform a real-time audio video data transmission with the second server.

5. The electronic device of claim 3, wherein the processing unit employs the authentic information to log in to the second server, and connects to another electronic device which is connecting to the second server via the second server to perform a real-time audio video data transmission.

6. The electronic device of claim 5, wherein the electronic device further comprises:
a Software Development Kit (SDK), employing HyperText Markup Language (HTML) or Javascript to provide an interface connector for connections with other programs;
wherein the processing unit connects to the second server via the SDK, and performs the real-time audio video data transmission with the other electronic device.

7. A communication system, comprising:
a first server;
a second server; and
an electronic device, arranged to connect to a first server for downloading a webpage and display the webpage on a display unit of the electronic device;
wherein when a specific icon in the webpage is selected, the electronic device receives an authentic information from the first server, and performs an audio video data transmission with the authentic information and a second server;
wherein when the second server and the electronic device cannot perform the audio video data transmission, the second server actively transmits an IP address to the electronic device, and the electronic device automatically employs the IP address to connect to a third server, and employs the authentic information obtained from the first server to perform the audio video data transmission with the third server.

8. The communication system of claim 7, wherein the webpage provides a content of an online meeting or an online lecture, and provides an account log in and/or a paying mechanism.

9. The communication system of claim 8, wherein the authentic information comprises a group identified number of the online meeting or the online lecture.

10. The communication system of claim 9, wherein the electronic device employs the authentic information to log in to the second server, and perform a real-time audio video data transmission with the second server.

11. The communication system of claim 9, wherein the electronic device employs the authentic information to log in to the second server, and connects to another electronic device which is connecting to the second server via the second server to perform a real-time audio video data transmission.

12. The communication system of claim 11, wherein the electronic device comprises:
a Software Development Kit (SDK), employing HyperText Markup Language (HTML) or Javascript to provide an interface connector for connections of the other programs;
wherein a processing unit of the processing unit connects to the second server via the SDK, and performs the real-time audio video data transmission with the other electronic device.

13-14. (canceled)

15. An audio video data transmission method, comprising:
connecting to a first server for downloading a webpage and displaying the webpage on a display unit;
receiving an authentic information from a first server when a specific icon in the webpage is selected; and
employing the authentic information and a second server to perform an audio video data transmission;
when the audio video data transmission cannot be performed with the second server, receiving an IP address from the second server, and employing the IP address to connect to a third server, and employing the authentic information obtained from the first server to perform the audio video data transmission with the third server.

16. The method of claim 15, wherein the webpage provides a content of an online meeting or an online lecture, and provides an account log in and/or a paying mechanism.

17. The method of claim 16, wherein the authentic information comprises a group identified number of the online meeting or the online lecture.

18. The method of claim 17, wherein the steps of employing the authentic information and a second server to perform an audio video data transmission comprise:
employing the authentic information to log in to the second server, and performing a real-time audio video transmission with the second server.

19. The method of claim 17, wherein the steps of employing the authentic information and a second server to perform an audio video data transmission comprise:
employing the authentic information to log in to the second server, and performing a real-time audio video transmission with an electronic device which is connecting to the second server via the second server.

20. The method of claim 19, wherein the method further comprises:
connecting to the second server via a Software Development Kit (SDK), and performing the real-time audio video data transmission with the electronic device, wherein the SDK employs HyperText Markup Language (HTML) or Javascript to provide an interface connector for connections of the other programs.
